(19) United States
(12) Patent Application Publication
(10) Pub. No.: US 2019/0270062 A1
(43) Pub. Date: Sep. 5, 2019

(54) Distribution system of fluids without resorting to the use of conventional piping system

(71) Applicant: Borel Marty Cely DE BELKO, Ypsilanti, MI (US)

(72) Inventor: Borel Marty Cely DE BELKO, Ypsilanti, MI (US)

(21) Appl. No.: 16/039,346

(22) Filed: Jul. 19, 2018

Related U.S. Application Data
(60) Provisional application No. 62/534,242, filed on Jul. 19, 2017.

(51) Int. Cl. B01J 8/04

(52) U.S. Cl. CPC B01J 8/0492; F17C 2270/05; F17C 2205/0391; F17C 2205/0338

(57) ABSTRACT

The invention relates to a new system of distribution of fluids over long distances through space without resorting to the conventional usage of the pipeline system. It consists of three facilities, namely the preparation facility (FIGS. 2 and 3), the fluid transmission/emission facility (FIGS. 4 and 6) and the reception facility (FIGS. 6 and 7).

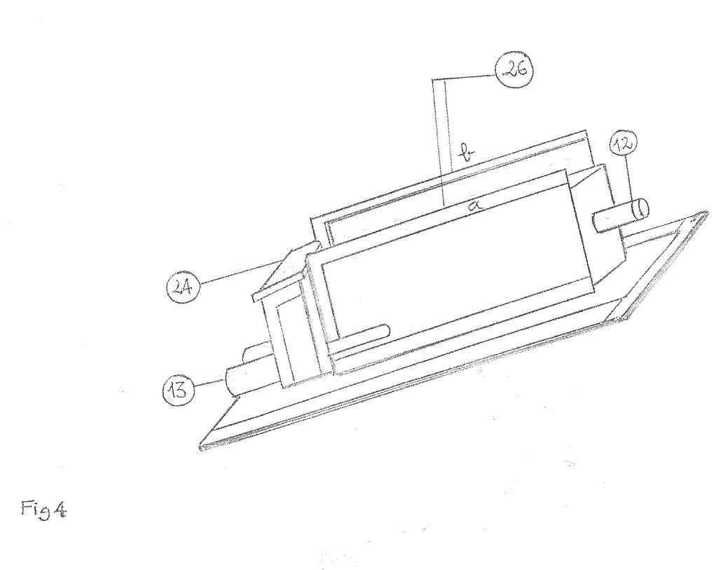

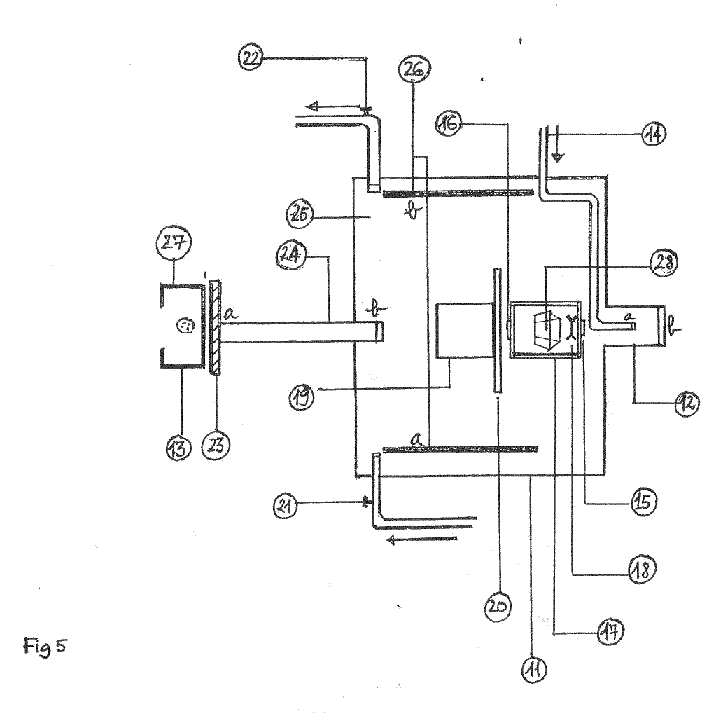

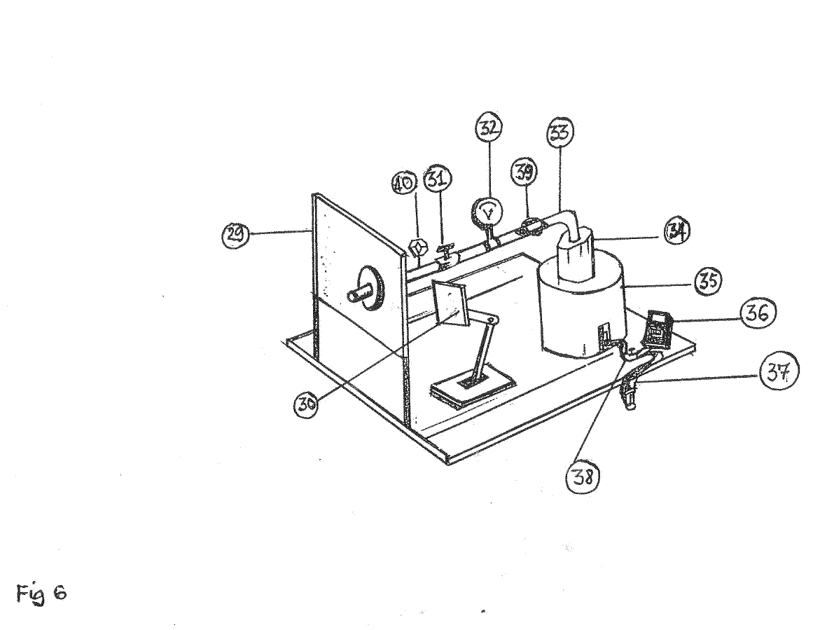

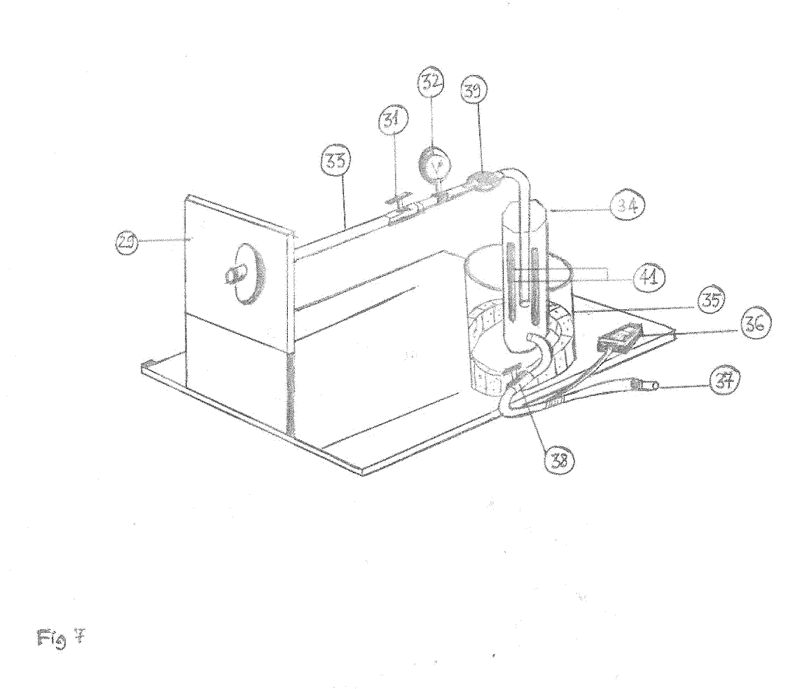

Indeed, the liquid is raised to a given temperature at the level of the preparation tank (1) until the gas obtaining that is thereafter supplied to the fluid transmission facility (FIGS. 4 and 5) through the evacuator tube (7) provided with a valve (8) which serves to block the gas while the fluid transmission facility (FIGS. 4 and 5), by means of the servomechanism (25), produces energy due to zinc and metalloid alloy fission in the presence of gem crystal. Once energy propelled in space towards the reception facility (FIGS. 6 and 7), the valve (8) is open to allow the gas to pass towards the fluid transmission/emission facility (FIGS. 4 and 5) to use the energy corridor (A) which leads it to the reception facility (FIGS. 6 and 7). Thus the gas arrives at the reception (33) through which it is supplied to the gas holder (24) included in the liquefaction tank (35) placed under the temperature of −256 degree Celsius, which converts the gas to liquid state while retaining its physicochemical properties.

### A. FIELD OF INVENTION

The present invention relates to a fluid distribution system without resorting to the use of conventional piping system.

### B. BACKGROUND

Since the late 19th century, the state of technology reveals that the piping system fluid is today made up of household pipes on an industrial scale.

This system has many drawbacks: the risk of contamination of fluids and environmental destruction, high cost production facilities and distribution, flow distribution greatly reduced, including the time taken by this distribution.

The present invention aims to overcome these drawbacks, because it presents a new system for distributing fluids at long distances, without using the current system of conducting water, gas, oil or other fluid through pipes.

In fact, the new system can propel the fluids in a gaseous state, through the space, to the receiver, which converts them into liquid. Thus, it allows, for example, to refuel aircrafts in flight, military gear fighting far from their base and to distribute water to several water towers.

### C. DETAILED DESCRIPTION OF THE INVENTION

The new fluid distribution system is made up of (3) facilities, namely, the preparation facility, the fluidic emission facility and the reception facility.

The implementation of the invention is understood through the following description with reference to the figures in the appendices” It is by no means exhaustive.

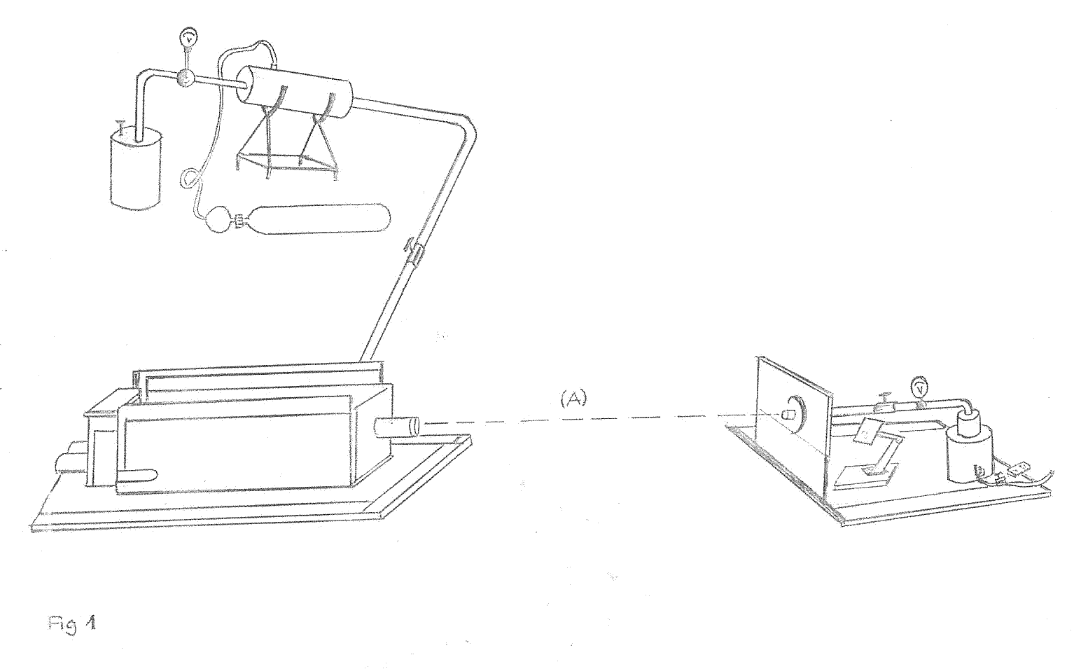

FIG. 1 shows a general view of the facility

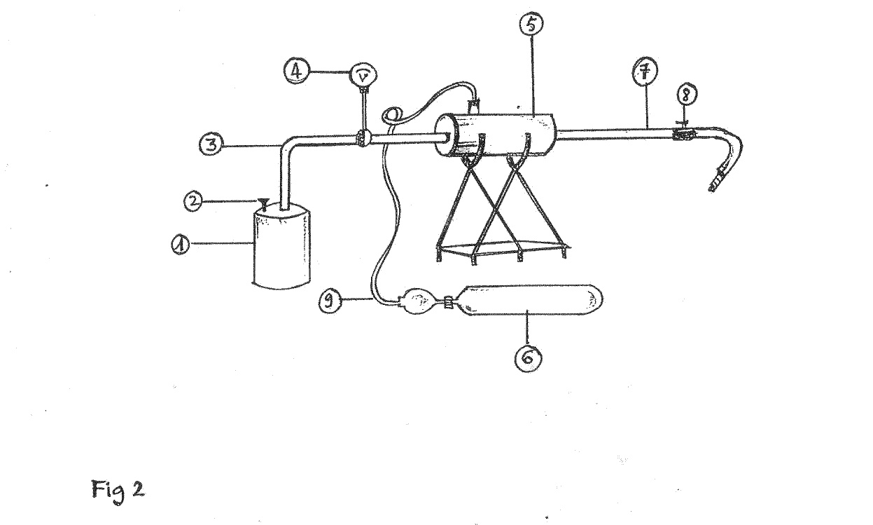

FIG. 2 is an external view of the preparation facility

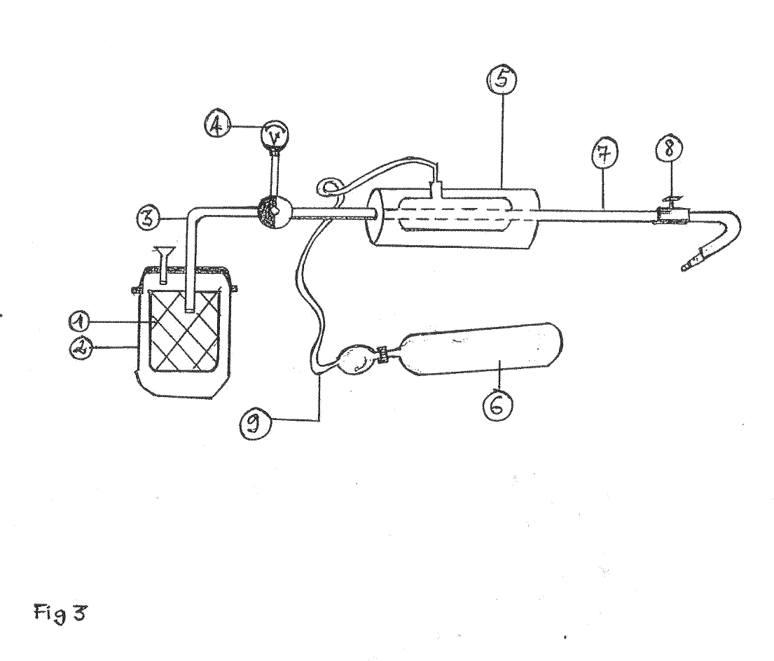

FIG. 3 is a section of the preparation facility

FIG. 4 shows the fluid emission facility

FIG. 5 shows a section of the fluids emission facility

FIG. 6 shows the reception facility

FIG. 7 is a section of the reception facility

The preparation facility (FIGS. 2 and 3) is used to raise, from a heat source, a body fluid or gas at a given temperature that it carries thereafter to a regulator (5) and finally transmits to the fluids facility (4 et 5). It consist; of a preparation tank (1) provided with an exhaust tube (3) to which is attached a pressure gauge (4). At the extremity of the exhaust tube (3) is arranged a regulator (5) attached to an ionic liquefied hydrogen catalyst (6). After the regulator (5) is attached an evacuating tube (7) on which there is a valve (8) connected to the transmission facility (FIGS. 4 and 5).

The fluid emission facility (FIGS. 4 and 5) is made of a small capsule (13) which is the particle trap or sensor on which are fixed a photo-sensitive plate (23) and an emission energy tube (12)”

An irradiation tube (24) is coupled to the light sensitive plate (23) by one end and connected to the servomechanism (25) by the other end (b). The servomechanism (25) contains two side-mirror plates (26a and 26b) in the center of which is a zinc alloy and liquefied metalloid (19) in which is inhibited a crystal gem that supplies energy through the discharge pipe (12)”.

At the level of laterally placed mirrors (26a and 26b), the mirror (a) is close to a cold water pump (21) which consists to expel the air which is located in the servomechanism (25); and another pump (22) fixed to the mirror (b) draws air and cold water for purifying servomechanism”. And cold water exits as hot water at the level of mirror. (b).

The reception facility (FIGS. 6 and 7) is provided with a lead and zinc alloy plate (29) on which is fixed a tube (33). On the side of the tube (33) are placed a valve (31), a pressure gauge (32), and a filter (39) whose end is connected to a gas holder (34), all the structure incorporated in a liquefaction tank (35) provided with a counter (36) for measuring the flow of received fluids and a valve (38) for collecting fluids. An independent boron plate (30) attached between the liquefaction tank (35) and the lead and zinc alloy plate (29) receives energy/power from the emission facility (FIGS. 4 and 5) through the boron plate (30) which stabilizes the structure of the gaseous molecule including energy reflected by the boron plate (30) serving for recognition at the received monochromatic frequency.

### Use:

A quantity of a liquid is poured into the preparation tank (1) and heated to gasification. The obtained gas is brought the regulator (5) which reduces its speed and imposes a new speed by means of an ionic catalyst composed of liquid hydrogen. Thereafter, the gas is conducted to the evacuator (7) after which there is a valve (8) closed.

While the valve (8) is closed, the fluids emission facility (FIGS. 4 and 5) is electrically powered at the level of the capsule (13) serving as particles sensor.

The resulting energy is automatically transmitted via the photosensitive plate (23) and takes the path of the irradiator tube (24) leading to another zinc alloy capsule (19) and a liquefied metalloid in the presence of a rock crystal and this causes an energy that is propelled through the evacuator tube (12).

The energy fission in contact with the prism (28) of the divergent lens (18) creates an energy corridor (A) through the gap for a given time.

Once the valve (8) open, the gas is discharged to the emission facility (FIGS. 4 and 5) which carries it through the energy corridor (A) to the reception facility (FIGS. 6 and 7).

The Independent boron plate (30) plays a role of energy sensor from the emission facility (FIGS. 4 and 5) that it reflects to the lead and zinc plate (29) to serve as a recognition function of the monochromatic frequency intended for it.

Once the valve (31) of the reception facility (FIGS. 2 and 3) open, the gas coming from the fluid emission facility (FIGS. 4 and 5) by the energy corridor (A) passes, indicated by a pressure gauge (32), through a filter (39) which reduces its flow, and is then directed to the gas holder (34) having two carbon rods (41) placed in a liquefaction tank (35) previously cooled to a temperature of −256 degrees Celsius. Thus, the gas contacting the cold liquefies and we obtain the starting liquid,

### Event of Fluids Emission to Many Reception Facilities by the Energy Corridor (A):

A black box (17) containing a prism (28) (FIGS. 4 and 5) after which are placed two openings (15 and 16) diametrically opposed.

The front opening (15) has a divergent lens (18) which serves to direct the energy from the zinc alloy and a liquefied metalloid in the presence of a gem crystal, which passes through the means of a plate of chloride silver (20) prior to propel into space by the energy corridors, such as the corridor (A). This energy at the lens (18) is divided into several small bundles after undergoing light decomposition at the prism (28) level.

Thus, small beams take different colors. The number of created beams corresponds to the number of energy corridors and the number of reception facilities.

Reception facilities consist of a monochromatic frequency received by another prism (40) which allows to recognize the frequency emitted relevant to the characteristics/features of each beam.

Indeed, the gas from the evacuator tuber (12) prior to propel, encounters a stationary state magnetic field at the end of spillway/exhaust pipe (12) which splits the number of beams that thereof result. Thus, the gases are routed through energy corridors available to them.

### Application:

To create seven (7) beams in the case of fluids emission to multiple reception facilities, it takes 70 grams of prism at emission/one (1) gram of prism at reception and 10 liters of zinc alloy and metalloid in the presence of one (1) gram of crystal gem, and a commercial lens of 0.4, including a 2 mm thick thin chloride silver plate (20) for maintaining energy for a 72 hour-period.

The merit of the new system is the fact that the fluids transmission is done, not by the use of current pipe supports, but by a distribution over long distances through space by an energy corridor. Besides the fluids transmission, the same system can serve for waves transmission to several reception facilities.

The materials used to create the different facilities of the system are among others metal, resin, wood and plastic.

1. New fluids distribution system without resorting to the use of conventional piping system characterized in that it comprises a preparation facility (FIGS. 2 and 3), a fluid transmission/emission facility (FIGS. 4 and 5) and a reception facility (FIGS. 6 and 7),

2. The invention according to claim 1, characterized in that the preparation facility (FIGS. 2 and 3) is provided with an ionic catalyst consisting of liquid hydrogen (6) whose role is to stabilize the molecular structure of the exhaust gas through the tube (7) connected to the transmission/emission facility (FIGS. 4 and 5), on which is placed a valve (8),

3. The invention according to claim 1, characterized in that the transmission facility (FIGS. 4 and 5) consists of a particle sensor (13) attached to a photosensitive plate (23) to which is connected a irradiator tube (24) whose end (b) is connects to the servomechanism (25) which distributes power to the capsule (19) comprising an alloy of zinc and liquefied metalloid on which is set a silver chloride plate (20) in front of which is placed a black box (17) containing a prism (28) and a diverging lens (18). The side ends of the black box (17) have two openings (15) and (16) diametrically opposed,

4. The invention according to claims 1 and 3, characterized in that the prism (28) in contact with the energy caused by the zinc alloy fission and liquefied metalloid in addition to gem crystal, decomposes and breaks this same energy into several beams by means of the lens (18) which creates the energy corridors such as energy corridor (A), through space, to the reception facility (FIGS. 6 and 7),

5. The invention according to claims 2 and 4, characterized in that, while the valve (8) is closed, the fluids transmission facility (FIGS. 4 and 5) is electrically powered at the capsule (13) level serving as a particle sensor,

6. The invention according to the claims 3 and 4, characterized in that the number of corridors is based on the mass of the prism (28),

7. The invention according to claim 1, characterized in that the reception facility (FIGS. 6 and 7) consists of a lead and zinc plate (29) by which is connected the reception tube (33) on which are placed a prism (40), a valve (31), a pressure gauge (32) and a filter (33) whose end is connected to a gas holder (34) included in a liquefaction tube (35) comprising a fluid distribution tube (37) with a valve (38) and a counter (36),

8. The invention according to claim 7, characterized in that the liquefaction tube (35) is placed under the temperature of −256 degrees (Celsius) to facilitate conversion of the gas into liquid,

9. The invention according to claim 6, characterized in that the independent boron plate (30) plays a role of power sensor from the transmission facility (FIGS. 4 and 5) that it reflects to the lead and zinc plate (29) to serve as a recognition point depending on the monochromatic frequency intended for it,

10. The invention according to claim 6, characterized in that the gas holder (34) is provided with two carbon bars (41) that purify received fluid substance molecules in order to maintain their physical and chemical properties at the reception point.
